(19) United States
(12) Patent Application Publication
(10) Pub. No.: US 2013/0119327 A1
(43) Pub. Date: May 16, 2013

(54) Flame Retardant Foam Polystyrene Bead and Method for Manufacturing the Same

(71) Applicant: Cheil Industries Inc., Gumi-si (KR)

(72) Inventors: Sang Hyuk KIM, Uiwang-si (KR); Sa Eun CHO, Uiwang-si (KR); Don Keun LEE, Uiwang-si (KR)

(73) Assignee: CHEIL INDUSTRIES INC., Gumi-si (KR)

(21) Appl. No.: 13/735,110

(22) Filed: Jan. 7, 2013

Related U.S. Application Data
(63) Continuation-in-part of application No. PCT/KR2010/009534, filed on Dec. 29, 2010.

(30) Foreign Application Priority Data
Jul. 8, 2010 (KR) 10-2010-0065707

(51) Int. Cl. C09K 21/14

(52) U.S. Cl. CPC C09K 21/14
USPC 252/601; 264/54

(57) ABSTRACT

A flame retardant foam polystyrene bead comprises: (A) a mixed resin including (a1) about 90 wt % to about 99 wt % of a styrene resin and (a2) about 1 wt % to about 10 wt % of a char-generating thermoplastic resin; (B) inorganic foam particles dispersed in the mixed resin; and (C) a foaming agent impregnated into the mixed resin containing the dispersed inorganic foam particles. The foam produced using the flame retardant foam polystyrene bead can have good flame retardancy, insulation, and mechanical strength properties.

### CROSS-REFERENCE TO RELATED APPLICATIONS

This application is a continuation-in-part of International Application No. PCT/KR2010/009534, filed Dec. 29, 2010, pending, which designates the U.S., published as WO 2012/005424, and is incorporated herein by reference in its entirety, and claims priority therefrom under 35 USC Section 120. This application also claims priority under 35 USC Section 119 from Korean Patent Application No. 10-2010-0065707, filed Jul. 8, 2010, in the Korean Intellectual Property Office, the entire disclosure of which is also incorporated herein by reference.

### FIELD OF THE INVENTION

The present invention relates to a flame retardant foam polystyrene bead and a method for manufacturing the same.

### BACKGROUND OF THE INVENTION

Generally, foam molded articles of expandable polystyrenes can exhibit high strength, light weight, buffering, waterproofing, heat retention and thermal insulation properties and thus are used as packaging materials for home appliances, boxes for agricultural and fishery products, buoys, thermal insulation materials for housing and the like. Seventy percent or more of domestic demand for expandable polystyrenes are for thermal insulation materials for housing or cores of sandwich panels.

However, in recent years, the use of such expandable polystyrenes has been restricted since they are being blamed for fires. Thus, in order for the expandable polystyrenes to be employed as thermal insulation materials for housing and the like, it is necessary for the expandable polystyrenes to have flame retardancy to the level of flame retardant materials.

Korea Patent No. 0602205 discloses a method for manufacturing incombustible flame retardant polystyrene foam particles by coating expanded graphite, a thermosetting resin and a curing catalyst onto polystyrene foam particles and curing the resultant coated particles.

Korea Patent No. 0602196 discloses a method for manufacturing flame retardant polystyrene foam particles, which includes coating a metal hydroxide compound selected from the group consisting of aluminum hydroxide (Al(OH)₃), magnesium hydroxide (Mg(OH) ₂) and a mixture thereof, a thermosetting liquid phenol resin, and a curing catalyst for the phenol resin onto polystyrene foam particles and crosslinking the resultant coated particles.

In these patents, the surfaces of foam beads are crosslinked with a thermosetting resin, which inhibits secondary foaming of the beads by steam. Accordingly, these methods can decrease of strength and fusion between particles in the course of manufacturing molded articles (panels). Furthermore, these methods can cause environmental pollution due to the use of thermosetting resins, such as phenol, melamine and the like; they can need additional facility investment to coat thermoset resins or inorganic materials; and they can cause deterioration in physical properties of resins due to the use of the inorganic materials.

Therefore, there is a need for a method for manufacturing a flame retardant polystyrene foam resin capable of inhibiting fusion between particles and decrease of strength while preventing environmental pollution in the course of manufacturing molded articles.

### SUMMARY OF THE INVENTION

The present invention relates to a flame retardant foam polystyrene bead. The foam polystyrene bead, which does not have a self-extinguishable flame retardant, can have good flame retardancy above flame retardant materials according to KS F ISO 5660-1. The flame retardant foam polystyrene bead is capable of being manufactured using commercially available products without any separate styrene polymerization processes or flame retardant coating processes. The flame retardant foam polystyrene bead can exhibit good flame retardancy, thermal insulation and excellent mechanical strength. The flame retardant foam polystyrene bead is capable of being manufactured with minimal facility investment and with minimal or no environmental pollution. The flame retardant foam polystyrene bead can have good processability. The flame retardant foam polystyrene bead can have an increased content of carbon particles and does not require any separate selection step.

The present invention further provides a flame retardant polystyrene foam produced using the flame retardant foam polystyrene bead. The flame retardant polystyrene foam produced using the flame retardant foam polystyrene bead can be suitable for a sandwich panel due to outstanding balance of physical properties such as flame retardancy, thermal conductivity and mechanical strength.

The present invention also provides a method for manufacturing a flame retardant foam polystyrene bead. The method can provide flame retardant foam polystyrene bead having a desired size at high yield.

The flame retardant foam polystyrene bead includes: (A) a mixed resin including (a1) about 90 wt % to about 99 wt % of a styrene resin and (a2) about 1 wt % to about 10 wt % of a char-generating thermoplastic resin; (B) inorganic foam particles dispersed in the mixed resin; and (C) a foaming agent impregnated into the mixed resin containing the dispersed inorganic foam particles. The flame retardant foam polystyrene bead can exhibit good flame retardancy, thermal insulation and excellent mechanical strength by introducing a char-generating thermoplastic resin and inorganic foam particles into a styrene resin. In one embodiment, the styrene resin (a1) may have a weight average molecular weight in the range of about 180,000 g/mol to about 300,000 g/mol.

In one embodiment, the char-generating thermoplastic resin (a2) may have an oxygen bond, an aromatic group or a combination thereof, in a backbone of the char-generating thermoplastic resin.

In one embodiment, the char-generating thermoplastic resin (a2) may include polycarbonate, polyphenylene ether, polyurethane, polyphenylene sulfide, polyester, and/or polyimide resins.

In another embodiment, the char-generating thermoplastic resin (a2) may include polycarbonate, polyphenylene ether, and/or polyurethane resins.

The inorganic foam particles (B) may include expanded graphite, silicate, perlite and/or white sand.

In one embodiment, the inorganic foam particles (B) may be present in an amount of about 3 parts by weight to about 50 parts by weight based on about 100 parts by weight of the mixed resin (A).

The inorganic foam particles (B) may have an average particle diameter of about 170 μm to about 1,000 μm.

The foaming agent (C) may be present in an amount of about 3 parts by weight to about 8 parts by weight based on about 100 parts by weight of the mixed resin containing the dispersed inorganic foam particles.

The flame retardant foam polystyrene bead further may include at least one additive selected from the group consisting of antiblocking agents, nucleating agents, antioxidants, carbon particles, fillers, antistatic agents, plasticizers, pigments, dyes, thermal stabilizers, UV absorbers, flame retardants, and combinations thereof.

The flame retardant foam polystyrene bead may have an average particle diameter of about 0.5 mm to about 3 mm. Further, the foam produced using the flame retardant foam polystyrene bead may have a residual layer thickness of about 10 mm or more without causing any cracks when measured after heating a sample having a thickness of 50 mm at 50 kW/m² of radiation heat from a cone heater for five minutes in accordance with KS F ISO 5560-1.

The present invention also relates to a method for manufacturing the flame retardant foam polystyrene bead. In one embodiment, the method includes: mixing (a1) a styrene resin, (a2) a char-generating thermoplastic resin and (B) inorganic foam particles to produce a mixed composition; extruding the mixed composition; and impregnating a foaming agent into the extruded mixed composition.

In one embodiment, the mixed composition may include about 3 to about 50 parts by weight of inorganic foam particles based on about 100 parts by weight of the mixed resin including about 90 wt % to about 99 wt % of the styrene resin (a1) and about 1 wt % to about 10 wt % of the char-generating thermoplastic resin (a2).

The styrene resin (a1) may be resin pellets having a weight average molecular weight of about 180,000 g/mol to about 300,000 g/mol.

The styrene resin (a1) may be pellets including at least one additive selected from the group consisting of antiblocking agents, nucleating agents, antioxidants, carbon particles, fillers, antistatic agents, plasticizers, pigments, dyes, thermal stabilizers, UV absorbers, flame retardants, and combinations thereof.

In one embodiment, the mixed composition may be extruded by adding at least one additive selected from the group consisting of antiblocking agents, nucleating agents, antioxidants, carbon particles, fillers, antistatic agents, plasticizers, pigments, dyes, thermal stabilizers, UV absorbers, flame retardants, and combinations thereof.

The flame retardant foam polystyrene bead according to the present invention can exhibit good flame retardancy; it may be produced using existing commercially available products without requiring any separate styrene polymerization processes or flame retardant coating processes; it can exhibit good flame retardancy, thermal insulation and excellent mechanical strength properties; it may cause minimal or no environmental pollution; it is capable of being manufactured with little facility investment; it can have good processability; it may be manufactured at high yield; it can increase carbon particle percentage; and it does not require any separate selection steps. The present invention also provides a method for manufacturing the flame retardant foam polystyrene bead.

### DETAILED DESCRIPTION OF THE INVENTION

The present invention now will be described more fully hereinafter in the following detailed description of the invention, in which some, but not all embodiments of the invention are described with reference to the accompanying drawings. Indeed, this invention may be embodied in many different forms and should not be construed as limited to the embodiments set forth herein; rather, these embodiments are provided so that this disclosure will satisfy applicable legal requirements.

A flame retardant foam polystyrene bead of the present invention includes (A) a mixed resin including (a1) a styrene resin and (a2) a char-generating thermoplastic resin; (B) inorganic foam particles dispersed in the mixed resin; and (C) a foaming agent impregnated into the mixed resin containing the dispersed inorganic foam particles.

(A) Mixed Resin

The mixed resin (A) of the present invention includes (a1) about 90 wt % to about 99 wt % of a styrene resin and (a2) about 1 wt % to about 10 wt % of a char-generating thermoplastic resin, based on the total weight (100 wt %) of the mixed resin including (a1) and (a2).

In some embodiments, the mixed resin (A) may include styrene resin (a1) in an amount of about 90, 91, 92, 93, 94, 95, 96, 97, 98, or 99% by weight by weight. Further, according to some embodiments of the present invention, the amount of styrene resin (a1) can be in a range from about any of the foregoing amounts to about any other of the foregoing amounts.

In some embodiments, the mixed resin (A) may include char-generating thermoplastic resin (a2) in an amount of about 1, 2, 3, 4, 5, 6, 7, 8, 9, or 10% by weight by weight. Further, according to some embodiments of the present invention, the amount of char-generating thermoplastic resin (a2) can be in a range from about any of the foregoing amounts to about any other of the foregoing amounts.

(a1) Styrene Resin

The styrene resin may be a homopolymer of styrene monomers, a copolymer of a styrene monomer and a copolymerizable monomer, or a mixture thereof. In another embodiment, the styrene resin may be a mixture of a styrene resin and other resins.

In one embodiment, the styrene resin (a1) may have a weight average molecular weight of about 180,000 g/mol to about 300,000 g/mol. Within the range, thermal insulation materials prepared using the styrene resin (a1) can have good processability and mechanical strength.

Examples of the styrene resin (a1) may include without limitation common polystyrenes (GPPS), high impact polystyrene (HIPS) resins, copolymers of styrene monomers and α-methylstyrene, acrylonitrile-butadiene-styrene copolymers (ABS), styrene-acrylonitrile copolymers (SAN), styrene-methyl methacrylate copolymers, blends of styrene resins, polymethyl methacrylate, and the like. These may be used alone or in combination of two or more thereof. In exemplary embodiments, general purpose polystyrenes (GPPS) and/or high impact polystyrene (HIPS) resins can be used.

(a2) Char-Generating Thermoplastic Resin

The char-generating thermoplastic resin (a2) usable in the present invention may have an oxygen bond or an aromatic group, or both an oxygen bond and an aromatic group in a backbone thereof.

Examples of the char-generating thermoplastic resin (a2) may include without limitation polycarbonate resins, polyphenylene ether resins, polyurethane resins, and the like. These may be used alone or in combination of two or more thereof. Examples of the char-generating thermoplastic resin (a2) may include without limitation polyphenylene sulfides (PPS), polyesters such as polyethylene terephthalate (PET) and/or polybutylene terephthalate (PBT), polyimides, and the like may also be used. These resins can be used alone or in combination of two or more thereof.

In one embodiment, the polycarbonate may have a weight average molecular weight of about 10,000 g/mol to about 30,000 g/mol, for example about 15,000 g/mol to about 25,000 g/mol.

Examples of polyphenylene ethers may include without limitation poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, a copolymer of poly(2,6-dimethyl-1,4-phenylene)ether and poly(2,3,6-trimethyl-1,4-phenylene)ether, a copolymer of poly(2,6-dimethyl-1,4-phenylene)ether and poly(2,3,5-triethyl-1,4-phenylene)ether, and the like, and combinations thereof. In exemplary embodiments, a copolymer of poly(2,6-dimethyl-1,4-phenylene)ether and poly(2,3,6-trimethyl-1,4-phenylene)ether and/or poly(2,6-dimethyl-1,4-phenylene)ether can be used. In exemplary embodiments, poly(2,6-dimethyl-1,4-phenylene)ether can be used.

The polyphenylene ether may have an intrinsic viscosity of about 0.2 dl/g to about 0.8 dl/g. Within this range, good thermal stability and workability can be obtained.

Due to high glass transition temperature, the polyphenylene ether may provide much higher thermal stability when mixed with the styrene resin, and may be mixed with the styrene resin in any ratio.

Thermoplastic polyurethane may be prepared by reacting diisocyanate with a diol compound, and may include a chain transfer agent, as needed. Examples of diisocyanates may include without limitation aromatic, aliphatic and/or alicyclic diisocyanate compounds. Examples of diisocyanates may include without limitation 2,4- tolylene diisocyanate, 2,6-tolylene diisocyanate, phenylene diisocyanate, 4,4′-diphenyl methane diisocyanate, 4,4′-diphenyl diisocyanate, 1,5-naphthalene diisocyanate, 3,3′-dimethylbiphenyl-4,4′-diisocyanate, o-, m- and/or p-xylene diisocyanate, tetramethylene diisocyanate, hexamethylene diisocyanate, trimethyl hexamethylene diisocyanate, dodecanemethylene diisocyanate, cyclohexane diisocyanate, dicyclohexylmethane diisocyanate, and the like, and combinations thereof.

Examples of diol compounds may include without limitation polyester diol, polycaprolactone diol, polyether diol, polycarbonate diol, and the like, mixtures thereof. For example, mention can be made of ethylene glycol, 1,2-propylene glycol, 1,3-propylene glycol, butane 1,2-diol, butane 1,3-diol, butane 1,4-diol, butane 2,3-diol, butane 2,4-diol, hexane diol, trimethylene glycol, tetramethylene glycol, hexene glycol and propylene glycol, polytetramethylene ether glycol, dihydroxy polyethylene adipate, polyethylene glycol, polypropylene glycol, and the like, and combinations thereof, without being limited thereto.

In the present invention, the char-generating thermoplastic resin (a2) may be present in an amount of about 1 wt % to about 10 wt %, for example about 3 wt % to about 7.5 wt %, and as another example about 4 wt % to about 7 wt %, in the mixed resin (A). If the amount of the char-generating thermoplastic resin (a2) is less than about 1 wt %, flame retardancy can be decreased as a result of decrease of char generation. If amount of the char-generating thermoplastic resin (a2) greater than about 10 wt %, mechanical properties can be decreased due to high glass transition temperature in preparation of thermal insulation materials.

(B) Inorganic Foam Particles

Examples of the inorganic foam particles may include without limitation expanded graphite, silicate, perlite, white sand, and the like, and combinations thereof.

In the present invention, the inorganic foam particles may act as char formers. Accordingly, it is necessary for the inorganic foam particles to maintain their shape without any collapse upon melt extrusion with resins and to have a uniform size in order to provide flame retardancy, mechanical strength, and thermal conductivity.

The inorganic foam particles may have an average particle diameter of about 170 μm to about 1,000 μm, for example about 200 μm to about 750 μm, and as another example about 300 μm to about 650 μm. Within this range, the inorganic foam particles can act as char formers, thereby obtaining desired flame retardancy, mechanical strength, and thermal conductivity.

The expanded graphite may be prepared by inserting chemical species capable of being inserted into interlayers into layered crystal structures of graphite and subsequently subjecting the same to heat or microwave. In one embodiment, the expanded graphite may be prepared by treating graphite with an oxidizing agent in order to introduce chemical species, such as SO₃²⁻ and NO₃⁻ between the graphite layers to form interlayered compounds, rapidly subjecting the graphite in which interlayered compounds are formed to heat or microwave in order to gasify the chemical species bonded between interlayers, and then expanding the graphite by means of pressure resulted from gasification hundreds to thousands of times. Those expanded graphite can be commercially available ones.

The expanded graphite can expand at 200° C. or more, for example at about 250° C. or more, as another example at about 265° C. or more, as another example at about 300° C. or more. As yet another example, the expansion temperature can range from about 310° C. to about 900° C. When the expanded graphite subjected to expansion at 200° C. or more is employed, the expanded graphite particles can act as char formers since the expanded graphite particles are not deformed or collapsed upon polymerization.

The silicates may be organically modified layered silicates and may include without limitation sodium silicate, lithium silicate, and the like, and combinations thereof. In the present invention, the silicate may generate char to form a blocking membrane, thereby maximizing flame retardancy.

Clays such as smectites, kaolinites, illites, and the like, and combinations thereof may be organically modified and used as organically modified layered silicates. Examples of clays may include without limitation montmorillonites, hectorites, saponites, vermiculites, kaolinites, hydromicas, and the like, and combinations thereof. Examples of modifying agents that can be used in order to organize the clays include without limitation alkylamine salts, organic phosphates, and the like, and combinations thereof. Examples of alkylamine salts may include without limitation didodecyl ammonium salt, tridodecyl ammonium salt, and the like, and combinations thereof. Examples of organic phosphates may include without limitation tetrabutyl phosphate, tetraphenyl phosphate, triphenyl hexadecyl phosphate, hexadecyl tributyl phosphate, methyl triphenyl phosphate, ethyl triphenyl phosphate, and the like, and combinations thereof.

The alkylamine salts and organic phosphates may be substituted with interlayered metal ions of layered silicates to broaden the interlayer distance, thereby providing layered silicates compatible with organic materials and capable of being kneaded with resins.

In one embodiment, as the organically modified layered silicate, montmorillonite modified by a C₁₂-C₂₀ alkyl amine salt may be used. In some embodiments, the organically modified montmorillonite (hereinafter referred to as “m-MMT”) may be organized at its interlayer with dimethyl dehydrogenated tallow ammonium instead of Na⁺.

The perlite may be heat-treated expanded perlite. The expanded perlite may be prepared by heating perlite at a temperature of about 870 to about 1100° C. to vaporize volatile components including moisture together with generation of vaporizing pressure, thereby expanding each granule by about 10 to about 20 fold via the vaporizing pressure to form round, glassy particles.

In one embodiment, the expanded perlite may have a specific gravity of about 0.04 g/cm² to about 0.2 g/cm². Within the range, the perlite exhibits good dispersion.

The white sand may be foam white sand.

In the present invention, the inorganic foam particles (B) may be present in an amount of about 3 parts by weight to about 50 parts by weight based on about 100 parts by weight of the mixed resin particles (A). In some embodiments, the inorganic foam particles (B) may be present in an amount of about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 49, or 50 parts by weight. Further, according to some embodiments of the present invention, the amount of inorganic foam particles (B) can be in a range from about any of the foregoing amounts to about any other of the foregoing amounts.

If the amount of the inorganic foam particles exceeds about 50 parts by weight, processability can be deteriorated. If the amount of the inorganic foam particles is less than about 3 parts by weight, flame retardancy can be deteriorated.

(C) Foaming Agent

The foaming agent is well known to those skilled in the art. Examples of foaming agents include without limitation C₃₋₆ hydrocarbons, such as propane, butane, isobutene, n-pentane, isopentane, neopentane, cyclopentane, hexane and cyclohexane; and halogenated hydrocarbons, such as trichlorofluoromethane, dichlorofluoromethane, dichlorotetrafluoroethane, and the like; as well as combinations thereof. In exemplary embodiments, pentane can be used.

In the present invention, the foaming agent may be present in an amount of about 3 parts by weight to about 8 parts by weight based on about 100 parts by weight of the total of the mixed resin (A) and the inorganic foam particles (B) [(A) +(B)]. In some embodiments, the foaming agent (C) may be present in an amount of about 3, 4, 5, 6, 7, or 8 parts by weight. Further, according to some embodiments of the present invention, the amount of foaming agent (C) can be in a range from about any of the foregoing amounts to about any other of the foregoing amounts.

When the foaming agent (C) is present in an amount within the above range, good processability can be ensured.

The flame retardant foam polystyrene bead may further include one or more conventional additives. Examples of additives may include without limitation antiblocking agents, nucleating agents, antioxidants, carbon particles, fillers, antistatic agents, plasticizers, pigments, dyes, heat stabilizers, UV absorbers, flame retardants, and the like. The additives may be used alone or in combination of two or more thereof.

The antiblocking agent may be optionally used to provide adhesion between particles upon foaming or to facilitate fusion between particles upon preparation of thermal insulation materials. For example, the antiblocking agent may be a copolymer of ethylene-vinyl acetate.

The nucleating agents may be polyethylene wax.

Examples of the flame retardants include without limitation phosphor flame retardants such as tris(2,3-dibromopropyl)phosphate, triphenylphosphate, bisphenol A diphenyl phosphate and the like; halogen flame retardants such as hexabromocyclododecane, tribromophenyl allylether, and the like; and combinations thereof. In exemplary embodiments, bisphenol A diphenylphosphate can be used.

Method for Manufacturing the Flame Retardant Foam Polystyrene Bead

The present invention further provides a method for manufacturing the flame retardant foam polystyrene bead. In one embodiment, the method includes: mixing (a1) a styrene resin, (a2) a char-generating thermoplastic resin and (B) inorganic foam particles to provide a mixed composition; extruding the mixed composition; and impregnating a foaming agent into the extruded mixed composition.

In one embodiment, the mixed composition may be prepared by mixing about 100 parts by weight of the mixed resin, which includes about 90 wt % to about 99 wt % of the styrene resin (a1) and about 1 wt % to about 10 wt % of the char-generating thermoplastic resin (a2), with about 3 to about 50 parts by weight of the inorganic foam particles (B).

The styrene resin (a1) may be in the form of pellets. In other words, any commercially available styrene resin pellets may be used without any separate styrene polymerization process, thereby providing an economically feasible and simple process. In one embodiment, the styrene resin pellets may have a weight average molecular weight of about 180,000 g/mol to about 300,000 g/mol.

In one embodiment, the styrene resin pellets may optionally include one or more additives. Examples of the additives include without limitation nucleating agents, antioxidants, carbon particles, fillers, antistatic agents, plasticizers, pigments, dyes, thermal stabilizers, UV absorbers, flame retardants and the like, and combinations thereof. These additives may be used alone or in combination of two or more thereof.

The styrene resin (a1) may be pellets containing at least one additive selected from the group consisting of nucleating agents, antioxidants, carbon particles, fillers, antistatic agents, plasticizers, pigments, dyes, thermal stabilizers, UV absorbers, flame retardants, and combinations thereof.

As such, the first pellets containing styrene resin may be mixed with the char-generating thermoplastic resin (a2) and the inorganic foam particles (B) to prepare a mixed composition.

Conventionally, the inorganic foam particles are coated onto outer surfaces of foam particles or added upon polymerization. However, in the case where the inorganic foam particles are added upon polymerization, the amount of the inorganic foam particles cannot be increased due to flocculation or collapse of the particles. In the case where the inorganic foam particles are coated onto the outer surfaces of the foam particles, final molded products can have low strength. Accordingly, the present invention may prevent decrease in strength of the final molded products as well as flocculation or collapse of the particles by mixing the first pellets obtained from polymerization of styrene with the inorganic foam particles.

Optionally, the mixed composition may further include conventional one or more additives. Examples of the additives include without limitation antiblocking agents, nucleating agents, antioxidants, carbon particles, fillers, antistatic agents, plasticizers, pigments, dyes, thermal stabilizers, UV absorbers, flame retardants and the like. These additives may be used alone or in combination of two or more thereof.

The mixed composition obtained by mixing the styrene resin (a1), the char-generating thermoplastic resin (a2) and the inorganic foam particles (B) are extruded to form second pellets.

The extruder is not particularly limited, but in order to obtain a desired grade, it is necessary to have a die plate hall diameter of about 0.7 mm to about 2.0 mm, for example about 0.7 mm to about 1.7 mm, and as another example about 1.0 mm to about 1.5 mm. The obtained second pellets can have a size of about 2 mm or less. Through extrusion, it is possible to obtain second pellets having a desired size at high yield.

The extrusion temperature can be adjusted to about 130° C. to about 250° C., for example about 150° C. to about 200° C.

By extruding before the introduction of the foaming agent, the present invention may enhance the content of carbon particles and obtain the desired size and grade at high yield without any separate selection step. In addition, the present invention may prevent explosion due to gas introduction upon extrusion.

The foaming agent is injected into the extruded second pellets to produce foam polystyrene. The foaming agent may be added in an amount of about 3 parts by weight to about 8 parts by weight based on about 100 parts by weight of the second pellets obtained by mixing the mixed resin with the inorganic foam particles.

In one embodiment, a dispersant and an emulsifying agent can be added to the second pellets and then heated to about 80° C. to about 125° C., followed by adding the foaming agent. After adding the foaming agent to the second pellets, the temperature of the mixture may be maintained at about 100° C. to about 120° C. for about 1 to about 6 hours.

The dispersant may be prepared by stirring about 0.001 to about 1.0 parts by weight of sodium pyrophosphate (10 hydrate) Na₄P₂O₇.10H₂O and about 0.001 to about 1.0 parts by weight of magnesium chloride (MgCl₂) in about 100 parts by weight of deionized water.

The emulsifying agent may be any conventional emulsifying agent and may include, for example, sodium benzoate (DSM COMPANY), tricalcium phosphate (BUNDNHEIM C13-08), and the like, and combinations thereof. The foam polystyrene prepared as mentioned above may be formed by injecting expandable gas into pellets having a constant size and thus the foam polystyrene having desired grade may be obtained at approximately 100% yield.

In one embodiment, the flame retardant foam polystyrene bead may have an average diameter of about 0.5 mm to about 3 mm.

The present invention further provides flame retardant foam produced using the flame retardant foam polystyrene beads.

The foam produced using the flame retardant foam polystyrene bead may have a residual layer thickness of about 10 mm or more, for example about 11 mm to about 45 mm when measured after heating a sample having a thickness of 50 mm at 50 kW/m² using a cone heater for five minutes in accordance with KS F ISO 5560-1.

The foam of the present invention may be employed as packaging materials for home appliances, boxes for agricultural and fishery products, thermal insulation materials for housing, and the like. Further, the foam can have good flame retardancy, mechanical strength and thermal insulation, and thus may be suitably used as thermal insulation materials for housing and cores of sandwich panels manufactured by inserting thermal insulation core between iron plates.

The present invention will be explained in more detail with reference to the following examples. These examples are provided for illustration only and are not to be in any way construed as limiting the present invention.

### EXAMPLES

### Example 1

To 95 parts by weight of GPPS pellets (a1) (GP HR-2390P00, Cheil Industries, Co., Ltd.) having a weight average molecular weight of 270,000 g/mol, 5 parts by weight of polyphenylene ether (a2) (PX100F, MEP Co., Ltd.) as a char-generating thermoplastic resin is added, followed by mixed with 15 parts by weight of an expanded graphite (B) (MPHSO3, ADT Co., Ltd.) having an average particle size of 297 μm and having an expansion temperature of 300° C. to prepare a mixed composition. The mixed composition is extruded through a twin-screw extruder having a die plate hall diameter of 1.5 mm for pelletization. 0.8 parts by weight of sodium pyrophosphate (10 hydrate) Na₄P₂O₇.10H₂O and 0.9 parts by weight of magnesium chloride (MgCl₂) are stirred in 100 parts by weight of deionized water in a reactor. Then, 100 parts by weight of the extruded pellets and 0.1 by weight of calcium stearate are added to the mixture and heated to a temperature of 125° C. Then, 8 parts by weight of pentane mixed gas is added to the mixture and maintained at a temperature of 125° C. for 6 hours to produce foam polystyrene beads. After drying for 5 hours, the coated foam polystyrene beads are placed in a plate molder and a steam pressure of 0.5 kg/cm² is applied thereto to obtain a desired foam molded article. Subsequently, the foam molded article is dried in a desiccator at 50° C. for 24 hours and cut to prepare specimens for measuring flame retardancy, thermal conductivity and mechanical strength.

The prepared specimens are subjected to experiments to measure their physical properties in a manner described below.

Methods for Measuring Physical Properties

(1) Flame retardancy: Flame retardancy is evaluated in accordance with KS F ISO 5660-1 for testing incombustibility of internal finish materials and structure for buildings. A core sample having a size of 100 mm×100 mm×50 mm is manufactured and heated for 5 minutes to determine whether cracking occurred and to determine the residual layer thickness (mm). Further, gas toxicity testing is also performed.

(2) Thermal conductivity (W/m·K): Thermal conductivity is measured by a method for measuring thermal conductivity of heat keeping materials as prescribed in KS L9016 when the sample has a specific gravity of 30 kg/m³. (3) Compressive strength (N/cm²): Compressive strength is measured by a method for measuring compressive strength of foam polystyrene heat keeping materials as prescribed in KS M 3808 when the sample has a specific gravity 30 kg/m³.

(4) Flexural strength (N/cm²): Flexural strength is measured by a method for measuring flexural strength of foam polystyrene heat keeping materials as prescribed in KS M 3808 when the sample has a the specific gravity of 30 kg/m³.

### Example 2

Specimens are prepared in the same manner as in Example 1 except that 5 parts by weight of bisphenol A diphenylene phosphate (CR-741, DAIHACHI Co., Ltd.) is further added as a flame retardant in the preparation of the mixed composition.

### Example 3

Specimens are prepared in the same manner as in Example 1 except that polycarbonate (SC-1620, Cheil Industries, Co., Ltd.) having a flow index (250° C., 12 kg) of 10.5 g/10 min is used as a char-generating thermoplastic resin instead of polyphenylene ether.

### Example 4

Specimens are prepared in the same manner as in Example 1 except that HIPS pellets (GP HF 2660, Cheil Industries, Co., Ltd.) having a weight average molecular weight of 220,000 g/mol are used as a styrene resin.

### Example 5

Specimens are prepared in the same manner as in Example 4 except that polycarbonate (SC-1620, Cheil Industries, Co., Ltd.) having a flow index (250° C., 12 kg) of 10.5 g/10 min is used as a char-generating thermoplastic resin instead of polyphenylene ether.

### Example 6

Specimens are prepared in the same manner as in Example 1 except that 15 parts by weight of expanded graphite (B-2) (KP5095, PingDu HuaDong Co., Ltd.) having an expansion temperature of 220˜250° C. and an average particle size of 279 μm is used.

### Comparative Example 1

Specimens are prepared in the same manner as in Example 1 except that 2 parts by weight of expanded graphite is used to prepare the mixed composition. In flame retardancy testing in accordance with KS F ISO 5660-1 for testing incombustibility of internal finishing materials and structure for buildings, due to lack of expanded carbon layer upon combustion, thermal transfer could not be prevented, which left little residual layer after complete combustion, thereby causing some cracks. Therefore, the specimens failed to exhibit physical properties equivalent to those of flame retardant materials.

### Comparative Example 2

Specimens are prepared in the same manner as in Comparative Example 1 except that polycarbonate (SC-1620, Cheil Industries, Co., Ltd.,) having a flow index (250° C., 12 kg) of 10.5 g/10 min is used as a char forming resin. In flame retardancy testing in accordance with KS F ISO 5660-1, due to lack of the expanded carbon layer upon combustion, thermal transfer could not be prevented, which left little residual layer after complete combustion, thereby causing cracking.

### Comparative Example 3

Specimens are prepared in the same manner as in Comparative Example 1 except that HIPS pellets (GP HF 2660, Cheil Industries, Co., Ltd.,) having a weight average molecular weight of 220,000 g/mol as a styrene resin and 2 parts by weight of expanded graphite having an average particle size of 297 μm are introduced. In flame retardancy testing in accordance with KS F ISO 5660-1, due to lack of expanded carbon layer upon combustion, thermal transfer could not be prevented, which left little residual layer after complete combustion, thereby causing cracking

### Comparative Example 4

Specimens are prepared in the same manner as in Example 1 except that 0.5 parts by weight of polycarbonate (SC-1620, Cheil Industries, Co., Ltd.,) having a flow index (250° C., 12 kg) of 10.5 g/10 min is used as a char-generating thermoplastic resin instead of polyphenylene ether. In flame retardancy testing in accordance with KS F ISO 5660-1, due to lack of expanded carbon layer upon combustion, thermal transfer could not be prevented, which left little residual layer after complete combustion, thereby causing cracking

### Comparative Example 5

Specimens prepared in the same manner as in Example 1 except that expanded graphite (B-1) having the same average particle size but a foaming temperature of 180° C. (MPH-502, ADT Co., Ltd.) is used. Upon extrusion through the twin screw extruder, the expanded graphite is expanded due to the extrusion temperature and thus it is impossible to carry out regular extrusion.

### Comparative Example 6

Specimens are prepared in the same manner as in Example 1 except that 15 parts by weight of expanded graphite (B-3) (KP295, PingDu HuaDong Co., Ltd.) having an average particle size of 74 μm is mixed to prepare the mixed composition. In flame retardancy testing in accordance with KS F ISO 5660-1, due to lack of expanded carbon layer upon combustion, thermal transfer could not be prevented, which left little residual layer after complete combustion, thereby causing cracking Therefore, the specimens failed to exhibit physical properties equivalent to those of flame retardant materials.

### Comparative Example 7

Specimens are prepared in the same manner as in Example 1 except that 15 parts by weight of expanded graphite (B-4) (KP195, PingDu HuaDong Co., Ltd.) having an average particle size of 149 μm is mixed to prepare the mixed composition. In flame retardancy testing in accordance with KS F ISO 5660-1, due to lack of expanded carbon layer upon combustion, thermal transfer could not be prevented, which left little residual layer after complete combustion, thereby causing cracking Therefore, the specimens failed to exhibit physical properties equivalent to those of flame retardant materials.

TABLE 1

| | | Example | | | | | |
|---|---|---|---|---|---|---|---|
| | | 1 | 2 | 3 | 4 | 5 | 6 |
| (a1) | GPPS | 95 | 95 | 95 | — | — | 95 |
| | HIPS | — | — | — | 95 | 95 | — |
| (a2) | PPE | 5 | 5 | — | 5 | — | 5 |
| | PC | — | — | 5 | — | 5 | — |

| | | | | | | |
|---|---|---|---|---|---|---|
| (B) | 15 | 15 | 15 | 15 | 15 | — |
| (B-1) | — | — | — | — | — | — |
| (B-2) | — | — | — | — | — | 15 |
| Flame retardant | — | 5 | — | — | — | — |
| Flame | 15 | 17 | 12 | 13 | 11 | 12 |
| retardancy | | | | | | |
| (residual layer | | | | | | |
| thickness: mm) | | | | | | |
| Cracking | No | No | No | No | No | No |
| Thermal | 0.032 | 0.033 | 0.033 | 0.033 | 0.034 | 0.033 |
| conductivity | | | | | | |
| Compressive | 18.8 | 18.3 | 18.0 | 18.0 | 17.7 | 18.2 |
| strength | | | | | | |
| Flexural | 37.2 | 37.1 | 37.2 | 37.2 | 37.5 | 34.1 |
| strength | | | | | | |

TABLE 2

| | | Comparative Example | | | | | | |
|---|---|---|---|---|---|---|---|---|
| | | 1 | 2 | 3 | 4 | 5 | 6 | 7 |
| (a1) | GPPS | 95 | 95 | — | 99.5 | 95 | 95 | 95 |
| | HIPS | — | — | 95 | — | — | — | — |
| (a2) | PPE | 5 | — | 5 | — | 5 | 5 | 5 |
| | PC | — | 5 | 0 | 0.5 | — | — | — |

| | | | | | | | |
|---|---|---|---|---|---|---|---|
| (B) | 2 | 2 | 2 | 15 | — | — | — |
| (B-1) | — | — | — | — | 15 | — | — |
| (B-2) | — | — | — | — | — | — | — |
| (B-3) | — | — | — | — | — | 15 | — |
| (B-4) | — | — | — | — | — | — | 15 |
| Flame retardant | — | — | — | — | — | — | 5 |
| Flame | 0 | 0 | 0 | 3 | Extrusion | 4 | 5 |
| retardancy | | | | | Impossible | | |
| (residual layer | | | | | | | |
| thickness: mm) | | | | | | | |
| Cracking | Occur | Occur | Occur | Occur | — | Occur | Occur |
| Thermal | 0.033 | 0.034 | 0.033 | 0.034 | — | 0.033 | 0.034 |
| conductivity | | | | | | | |
| Compressive | 17.8 | 18.0 | 18.1 | 17.9 | — | 18.0 | 17.9 |
| strength | | | | | | | |
| Flexural | 37.1 | 37.2 | 37.1 | 37.2 | — | 37.1 | 37.1 |
| strength | | | | | | | |

As can be seen from the results in Table 1, when the specimens of Examples 1 to 6 are subjected to flame retardancy testing in accordance with KS F ISO 5660-1, these specimens exhibited good flame retardancy having a residual layer thickness of 11 mm or more after the complete combustion. This is because the carbon layer expanded upon combustion could act as an insulating layer, which inhibited thermal transfer, thereby preventing thermal transfer to the rear side. Furthermore, it is confirmed that these specimens exhibit better mechanical strength and thermal insulation as compared with those of the comparative examples. On the other hand, the specimens of Comparative Examples 1-4 and 6-7 left little residual layer thickness, and in Comparative Example 5, extrusion is impossible.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A flame retardant foam polystyrene bead, comprising:
(A) a mixed resin comprising (a1) about 90 wt % to about 99 wt % of a styrene resin and (a2) about 1 wt % to about 10 wt % of a char-generating thermoplastic resin;
(B) inorganic foam particles dispersed in the mixed resin; and
(C) a foaming agent impregnated into the mixed resin containing the dispersed inorganic foam particles.

2. The flame retardant foam polystyrene bead according to claim 1, wherein the styrene resin (a1) has a weight average molecular weight in the range of about 180,000 g/mol to about 300,000 g/mol.

3. The flame retardant foam polystyrene bead according to claim 1, wherein the char-generating thermoplastic resin (a2) has an oxygen bond, an aromatic group or a combination thereof, in a backbone of the char-generating thermoplastic resin.

4. The flame retardant foam polystyrene bead according to claim 1, wherein the char-generating thermoplastic resin (a2) comprises polycarbonate resin, polyphenylene ether resin, polyurethane resin, polyphenylene sulfide resin, polyester resin, polyimide resin, or a combination thereof.

5. The flame retardant foam polystyrene bead according to claim 4, wherein the char-generating thermoplastic resin (a2) comprises polycarbonate resin, polyphenylene ether resin, polyurethane resin or a combination thereof.

6. The flame retardant foam polystyrene bead according to claim 1, wherein the inorganic foam particle (B) comprises expanded graphite, silicate, perlite, white sand or a combination thereof.

7. The flame retardant foam polystyrene bead according to claim 1, wherein the inorganic foam particles (B) are present in an amount of about 3 parts by weight to about 50 parts by weight based on about 100 parts by weight of the mixed resin (A).

8. The flame retardant foam polystyrene bead according to claim 1, wherein the inorganic foam particles (B) have an average particle diameter of about 170 μm to about 1,000 μm and an expansion temperature of about 200° C. or more.

9. The flame retardant foam polystyrene bead according to claim 1, wherein the foaming agent (C) is present in an amount of about 3 parts by weight to about 8 parts by weight based on about 100 parts by weight of the mixed resin containing the dispersed inorganic foam particles.

10. The flame retardant foam polystyrene bead according to claim 1, wherein the flame retardant foam polystyrene bead further comprises at least one additive comprising antiblocking agent, nucleating agent, antioxidant, carbon particle, filler, antistatic agent, plasticizer, pigment, dye, thermal stabilizer, UV absorber, flame retardant or a combination thereof.

11. The flame retardant foam polystyrene bead according to claim 1, wherein the flame retardant foam polystyrene bead has an average particle diameter of about 0.5 mm to about 3 mm.

12. A flame retardant polystyrene foam produced using the flame retardant foam polystyrene bead according to claim 1 and having a residual layer thickness of about 10 mm or more when measured after heating a sample having a thickness of 50 mm at 50 kW/m² using a cone heater for 5 minutes in accordance with KS F ISO 5560-1.

13. A method for manufacturing a flame retardant foam polystyrene bead, comprising:
mixing (a1) a styrene resin, (a2) a char-generating thermoplastic resin and (B) inorganic foam particles to provide a mixed composition;
extruding the mixed composition; and
impregnating a foaming agent into the extruded mixed composition.

14. The method according to claim 13, wherein the mixed composition comprises about 3 to about 30 parts by weight of inorganic foam particles based on about 100 parts by weight of the mixed resin comprising about 90 wt % to about 99 wt % of the styrene resin (a1) and about 1 wt % to about 10 wt % of the char-generating thermoplastic resin (a2).

15. The method according to claim 13, wherein the styrene resin (a1) has a weight average molecular weight in the range of about 180,000 g/mol to about 300,000 g/mol.

16. The method according to claim 15, wherein the styrene resin (a1) is in a pellet form comprising at least one additive comprising nucleating agent, antioxidant, carbon particle, filler, antistatic agent, plasticizer, pigment, dye, thermal stabilizer, UV absorbers, flame retardant or a combination thereof.

17. The method according to claim 13, wherein the char-generating thermoplastic resin (a2) has an oxygen bond, an aromatic group or a combination thereof, in a backbone of the char-generating thermoplastic resin.

18. The method according to claim 13, wherein the char-generating thermoplastic resin (a2) comprises polycarbonate resin, polyphenylene ether resin, polyurethane resin, polyphenylene sulfide resin, polyester resin, polyimide resin or a combination thereof.

19. The method according to claim 13, wherein the inorganic foam particle (B) comprises expanded graphite, silicate, perlite, white sand, or a combination thereof.

20. The method according to claim 13, wherein the inorganic foam particles (B) have an average particle diameter of about 170 to 1,000 μm.

21. The method according to claim 13, wherein the mixed composition is extruded by adding at least one additive comprising antiblocking agent, nucleating agent, antioxidant, carbon particle, filler, antistatic agent, plasticizer, pigment, dye, thermal stabilizer, UV absorber, flame retardant, or a combination thereof.
